(19) United States
(12) Patent Application Publication
(10) Pub. No.: US 2020/0170236 A1
(43) Pub. Date: Jun. 4, 2020

(54) METHOD FOR APPLYING A SPRAY AGENT

(71) Applicant: Robert Bosch GmbH, Stuttgart (DE)

(72) Inventors: Hans-Arndt Freudigmann, Tuebingen (DE); Jochen Glasbrenner, Stuttgart (DE); Johanna Link-Dolezal, Denkendorf (DE); Olaf Ohlhafer, Erligheim (DE)

(21) Appl. No.: 16/624,991

(22) PCT Filed: Jun. 14, 2018
(86) PCT No.: PCT/EP2018/065756

§ 371 Date: Dec. 20, 2019

(30) Foreign Application Priority Data
Jun. 22, 2017 (DE) 10 2017 210 560.7

(51) Int. Cl. A01M 7/00; A01G 7/06

(52) U.S. Cl. CPC A01M 7/0089; A01M 7/0042; A01G 7/06; A01M 7/0085

(57) ABSTRACT

A method for applying a spray agent is described, in particular, a plant protection product, onto an agricultural area to be treated with the aid of a spraying device, including a spray agent tank and at least one fluidic connecting line from the spray agent tank to a nozzle. The method includes the following steps: selectively applying the spray agent onto an initial section of the agricultural area, and subsequently extensively applying a residual amount of spray agent onto a residual section of the agricultural area using a predefined application amount in such a way that, upon completion of the treatment of the agricultural area, essentially the entire residual amount of spray agent has been applied.

### FIELD

The present invention relates to a method for applying a spray agent and to a device for applying a spray agent, in particular an agricultural field sprayer. The present invention also relates to a control unit and to a computer program.

### BACKGROUND INFORMATION

During use of present-day field sprayers, the spray agents such as liquid fertilizers, growth regulators and pesticides (herbicides, insecticides, fungicides and the like) are completely dissolved or mixed in an included water tank or in a tank containing another carrier fluid. The farmer has to calculate the amount of the spray mixture to be applied and the necessary concentrations of the different spray agents in advance. In isolated instances, systems are available which avoid a complete premixing of the compounds. In this way, individual compounds may be carried undiluted in central tanks and be mixed as needed with the included water or the carrier fluid in a mixer in the central feed line (so-called central direct injection system, CDIS).

In the case of the application customary today, the field is divided into individual lanes or strips (the width depends on the working width of the available field sprayer), and the farmer consecutively follows these strips. At the end of the application, the so-called headland is treated.

In both instances described at the outset, the remaining mixed portion of the spray mixture/plant protection product has to be completely applied at the end of the application, and the lines have to be rinsed with water. This is usually carried out by the farmer, after completion of the actual application, diluting the leftover remainder of his spray mixture with water and applying it as an additional amount to a portion of the area already treated. The entire applied amount must not exceed the permissible amount of spray agent per area, so that care must be taken that this portion was previously not treated with the maximum permissible spray agent concentration.

This disposal of the residual amount does not provide any benefit within the meaning of plant protection; on the contrary, it has the inherent risk of resistances being developed since the plant protection products are possibly applied in an insufficient dosage.

If the residual amount is additionally diluted with water during the application, the dosage of the spray agent may drop below a critical value at which individual weeds are no longer killed—a resistance may be developed.

German Patent No. DE 10 2007 053 114 A1 describes an agricultural field sprayer for the extensive treatment of an agricultural area, including a regulating unit, which during the last fill continuously readjusts or varies the application amount as a function of the residual amount and the residual area in order to have the entire spray agent applied upon completion of the treatment of the entire area.

### SUMMARY

The present invention relates to a method for applying a spray agent, in particular a plant protection product, to an agricultural area to be treated with the aid of a spraying device, including a spray agent tank for the spray agent to be applied and at least one fluidic connecting line from the spray agent tank to a nozzle, including the steps:
selectively applying the spray agent onto an initial section of the agricultural area, and subsequently
extensively applying a residual amount of spray agent onto a residual section of the agricultural area using a predefined application amount in such a way that, upon completion of the treatment of the agricultural area, essentially the entire residual amount of mixed spray agent has been applied.

The present invention furthermore relates to a control unit, which is configured to control or activate the steps of this method, to a computer program, which is configured to control or activate the steps of the method, and to a machine-readable storage medium on which the computer program is stored.

The present invention furthermore relates to a device for applying a spray agent, in particular an agricultural field sprayer, including
a spraying device, including a spray agent tank and at least one fluidic connecting line from the spray agent tank to a nozzle
   and
an above-described control unit, which is configured to appropriately activate the spraying device.

The agricultural area may be a field, crop land, grassland or a pasture.

The spraying device preferably includes a plurality of nozzles and fluidic connecting lines. A fluidic connecting line may be a hose or a pipe. The spray agent tank may include a premixing tank or be designed as a premixing tank. The spraying device may include a central direct injection (CDI) system, including a unit for premixing the spray agent.

The agricultural area to be treated is divided into an initial section and a residual section. The initial section is the section of the agricultural area to which the spray agent is initially selectively applied or which is initially selectively treated. The residual section is consequently the still remaining section of the agricultural area to which the present or remaining or available residual amount of spray agent is subsequently extensively applied, or which is extensively treated with the present or remaining or available residual amount of spray agent. The initial section and the residual section may initially be variable and arise during the treatment as a result of the change or the switch from the step of selective application to the step of extensive application, i.e., the start of the step of extensive application. In this case, the start of the step of extensive application is selected in such a way that, upon completion of the treatment of the agricultural area, essentially the entire residual amount of mixed spray agent has been applied. However, the initial section and the residual section may also be predefined and thus be established in advance or at the beginning of the treatment. In this case, the step of extensive application starts when the residual section, and thus a certain position, is reached, the residual amount being selected or mixed in such a way that, upon completion of the treatment of the agricultural area, essentially the entire residual amount of mixed spray agent has been applied.

Within the scope of the present invention, a selective application may be understood to mean an application which is carried out selectively, for example as a function of detected plants or plant population/weed occurrence. This means, in other words, that the spray agent, during the selective application, is only delivered, for example, when some degree of coverage with plants and/or a specific plant and/or a specific species/class/genus of plants, in particular weeds, is detected. With the aid of an optical and/or infrared identification unit, it is possible to detect plants, for example, based on a predetermined NVDI value (normalized difference vegetation index), which is formed of reflection values in the near infrared and visible red wavelength range of the light spectrum), by distinguishing biomass from soil. With the aid of a learned identification unit, it is furthermore possible to identify the detected plants with the aid of conventional methods—by determining a shape, size, species, number of leaves, leaf structure, number of buds, bud structure or other biological features which render a plant distinguishable from other plants and/or objects—so that the application of the spray agent only takes place selectively on these plants or weeds. The selective application, however, may also take place as a function of a plant disease, fungal infestation and/or insect infestation. A detection of the area to be treated may also take place manually or based on other data material, such as satellite or drone images, yield mappings and the like. In the step of selective application, consequently only the portion or the area of the initial section in which plants to be treated are detected is treated. The selective application thus takes place discontinuously.

Within the scope of the present invention, an extensive application may be understood to mean an application which is carried out extensively, without the detection and thus independently from a presence of a plant or a weed. In the step of extensive application, essentially the entire residual section or the entire area of the residual section is consequently treated with the residual amount, independently from plant/weed infestation. The extensive application may thus take place continuously or through a specific application pattern.

The residual amount is preferably the amount of mixed spray agent instantaneously present or remaining or available in the spraying device. Accordingly, the residual amount may be the instantaneously present or remaining or available amount of mixed spray agent in the spray agent tank and/or the at least one fluidic connecting line. The spray agent tank may include a premixing tank or be designed as a premixing tank. The concentration of the mixed residual amount of spray agent is known in the process.

The extensive application furthermore takes place using a predefined application amount per area in such a way that, upon completion of the treatment of the agricultural area or of the residual section of the agricultural area, essentially the entire residual amount of mixed spray agent has been applied. A predefined application amount may be understood to mean an application amount established in advance or at the beginning of the treatment. The predefined application amount is an essentially constant application amount per area. The application amount is thus independent from the area of the residual section which remains or is yet to be treated.

Accordingly, it is not necessary to regulate the application amount with respect to the residual area. The defined application amount may be preset. The predefined application amount preferably depends on the plants to be treated or their species/class/genus. The defined application amount is preferably in a range of a permissible amount per spray agent per area for the corresponding application case. The extensive application thus takes place uniformly.

By deliberately and intelligently switching from a eco-friendly selective application to a resource-conserving extensive application using a defined application amount of the spray agent, the method according to the present invention and the device according to the present invention represent an optimal compromise between an eco-friendly treatment of an agricultural area on the one hand, and the avoidance of the residual amount problem explained at the outset on the other hand. This is achieved, in particular, by initially carrying out the eco-friendly operating mode of the selective application as long as possible, until a change into the operating mode of the extensive application becomes necessary to ensure that the spray agent is emptied completely, the operating mode of the extensive application using the defined application amount being less eco-friendly, but far more resource-conserving. As a result, on the one hand, only a minimum of plant protection product has to be mixed, which means a reduction of the required spray agent. On the other hand, there are almost no diluted spray agent residual amounts that have to be applied to the field, which additionally helps avoid the development of resistances. Another advantage is that the extensive application takes place on the residual section, and thus largely on the headland of the agricultural area, which is generally infested to a greater extent with weeds or weeds in any event. With the aid of the present invention, it is consequently possible to carry out a treatment of an agricultural area in an eco-friendly and very simple and resource-conserving manner, ensuring that the spray agent is completely used up upon completion of the treatment.

It is advantageous when the step of extensive application is started as a function of the residual amount of spray agent and the area of the residual section. This means, in other words, that the residual amount of spray agent in the spraying device and the still remaining untreated area are ascertained, for example, with the aid of a digital map or data of the field geometry and GPS data, to change or switch, as a function thereof, from the step of selective application to the step of extensive application. In a step of ascertaining an area that is still treatable, the value of the area which is treatable with a residual amount (of mixed spray agent) present in the spraying device with an extensive application using a predefined application amount per area may be ascertained with the aid of a processing unit. In a step of ascertaining the still remaining residual area, it is possible with the aid of the processing unit to ascertain the value of the still remaining untreated residual area of the agricultural area. In a further step of comparing, the ascertained value of the still treatable area may be compared to the ascertained value of the still remaining residual area. In a further step of activating, the spraying device may then be activated with the aid of a control unit in such a way that a switch occurs from the selective application to the extensive application as soon as the two values are essentially identical, so that, upon completion of the treatment of the agricultural area, essentially the entire residual amount of mixed spray agent has been applied. If, for example, residual amount x is present in the spraying device, which is sufficient to treat y m² area, a switch to an extensive application may occur at z meters(=y/width of the headland) before completion of the treatment. On these z meters, the present residual amount is easily applied in the desired defined application amount, independently from the plant/weed infestation.

Since, in the case of a selective application, it is always unclear or unknown how many plants to be treated, in particular weed clusters, are present in the remaining residual section, the spray agent amount that is still required cannot be exactly ascertained beforehand so that the entire residual amount of mixed spray agent is essentially applied upon completion of the treatment of the agricultural area. As a result of this measure, this problem may be easily solved by switching from the selective application to the extensive application as soon as the residual amount is just barely sufficient to extensively treat the residual area of the residual section with the predefined application amount per area.

It is furthermore advantageous when the residual section is predefined, in particular, is a headland of the agricultural area, the step of extensive application being started when the residual section is reached, and the residual amount of spray agent being selected in such a way, in particular, being mixed in such a way, that, upon completion of the treatment of the predefined residual section, essentially the entire residual amount of mixed spray agent has been applied. This means, in other words, that the residual amount of spray agent in the spraying device is accordingly adapted to, or mixed for, the known area of the predefined residual section, so that a defined residual amount of mixed spray agent is present in the spraying device during the change from the step of selective application to the step of extensive application, which is exactly sufficient for the remaining area of the predefined residual section. The predefined residual section may be defined by a position or position information and/or an area or a size of an area, which may be entered manually, for example. In a step of ascertaining, a position of the spraying device and/or of the agricultural field sprayer may be ascertained on the agricultural area in the process, for example with the aid of a digital map or data of the field geometry and GPS data. In a step of mixing, the residual amount of spray agent necessary for treating the predefined residual section may then be mixed when the predefined residual section is reached. In a further step of activating, the spraying device may then be activated with the aid of the control unit in such a way that a change occurs from the selective application to the extensive application as soon as the spraying device and/or the agricultural field sprayer has/have reached the predefined residual section, so that, upon completion of the treatment of the agricultural area, essentially the entire residual amount of mixed spray agent has been applied. However, the steps of mixing and of activating are only carried out when, upon reaching the predefined residual section, the instantaneously present residual amount is less than or equal to the spray agent amount necessary for the treatment, since otherwise the spraying device would not be empty at the end of the treatment.

As a result of this measure, the treatment may be carried out even more easily since the change to the extensive application takes place in a position-specific manner. The advantage here is that, in general, the edges of the agricultural areas which are treated at the end are also, for example, the most heavily infested, so that an edge section or the entire headland may be defined as the predefined residual section. When this section is reached, which is heavily infested in any event, it is thus possible very easily to mix the corresponding residual amount necessary for the extensive treatment and to change or switch to the step of extensive application.

The step of mixing the spray agent may preferably be carried out with the aid of a mixing device of the spraying device prior to the steps of applying the spray agent.

It is also advantageous when a step of rinsing the spray agent tank and/or the at least one fluidic connecting line is provided upon completion of the step of extensive application, a resulting rinsing amount being applied to the initial section, in particular to a sub-section of the initial section to which no or relatively little spray agent was applied in the steps of applying, so that the applied amount is in a range of a permissible amount per spray agent per area for the corresponding application case. As a result of this measure, it is possible to clean all parts of the spraying device which have come in contact with spray agent, and accordingly necessarily have to be cleaned, in a very simple and safe manner with water, after the entire spray agent has been applied or the agricultural area has been treated. The rinsing amount arising in the process, which has only a low concentration of spray agent, is advantageously only applied to untreated or slightly treated, and thus non-critical, locations, so that wash-off effects of previously applied spray agent by the rinsing amount is prevented.

In addition, a computer program product or computer program is advantageous, having program code which may be stored on a machine-readable carrier or memory medium such as a semiconductor memory, a hard disk memory or an optical memory, and which is used to carry out, implement and/or activate the steps of the method according to one of the specific embodiments described above, in particular if the program product or program is executed on a computer or a device.

The method according to the present invention may be implemented, for example, in software or hardware or in a mixed form made up of software and hardware, for example in a control unit.

The present invention furthermore relates to a device for applying a spray agent, in particular, to an agricultural field sprayer, including
a spraying device, including a spray agent tank and at least one fluidic connecting line from the spray agent tank to a nozzle;
a processing unit, which is designed to ascertain the area and/or driving distance which is treatable with a residual amount of mixed spray agent present in the spraying device with an extensive application using a predefined application amount;
   and
a display unit, which is designed to visualize the ascertained area and/or driving distance for an operator and/or to output a signal when the ascertained area and/or driving distance corresponds to an area and/or driving distance of a predefined residual section of the agricultural area.

The predefined residual section may be definable with the aid of an inputtable area or size of an area. In this way, the option is created for an operator of the agricultural field sprayer, for example a farmer who does not have any GPS data available for ascertaining his field size or the previously untreated area or the area of the headland, for intervening directly in the device or the method, for example, when no control unit is present, to manually start the steps of extensive application or also to prevent new spray agent from being mixed.

### BRIEF DESCRIPTION OF THE DRAWINGS

The present invention is described in greater detail hereafter by way of example based on the figures.

FIG. 1 shows a tractor including an agricultural field sprayer according to the present invention.

FIG. 2 shows a schematic illustration of an agricultural area which was treated according to a first exemplary embodiment of a method according to the present invention.

FIG. 3 shows a schematic illustration of an agricultural area which was treated according to a second exemplary embodiment of a method according to the present invention.

FIG. 4 shows a flow chart of a method according to another exemplary embodiment.

### DETAILED DESCRIPTION OF EXAMPLE EMBODIMENTS

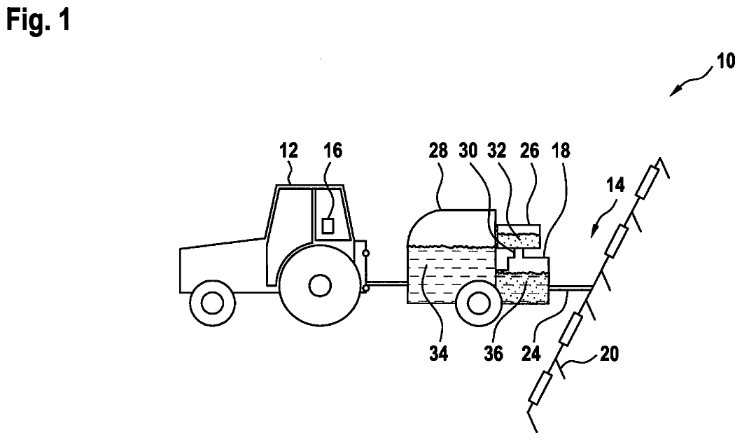

In FIG. 1, a device according to the present invention for applying a spray agent or an agricultural field sprayer is denoted overall by reference numeral 10.

Agricultural field sprayer 10 is mounted on a tractor 12 in the process.

Field sprayer 10 includes a spraying device 14 and a control unit 16.

Spraying device 14 includes a spray agent tank 18 and a nozzle 20. Spray agent tank 18 and nozzle 20 are fluidically connected to one another by a fluidic connecting line 24. Spraying device 14 furthermore includes a concentrate tank 26 and a water tank 28. Concentrate tank 26 and water tank 28 are also fluidically connected to spray agent tank 18 by a respective fluidic connecting line 30.

Spray agent tank 18 includes a mixing device (not shown) and is designed to mix a concentrate 32 from concentrate tank 26 and water 34 from water tank 28 to form a spray agent 36 to be applied. The respective amount of mixed spray agent 36 instantaneously present in spray agent tank 18, and possibly in fluidic connecting line 24 to nozzle 20, forms the residual amount of spray agent 36 in the spraying device 14.

Control unit 16 is configured to activate spraying device 14 accordingly to carry out the steps of the method described hereafter.

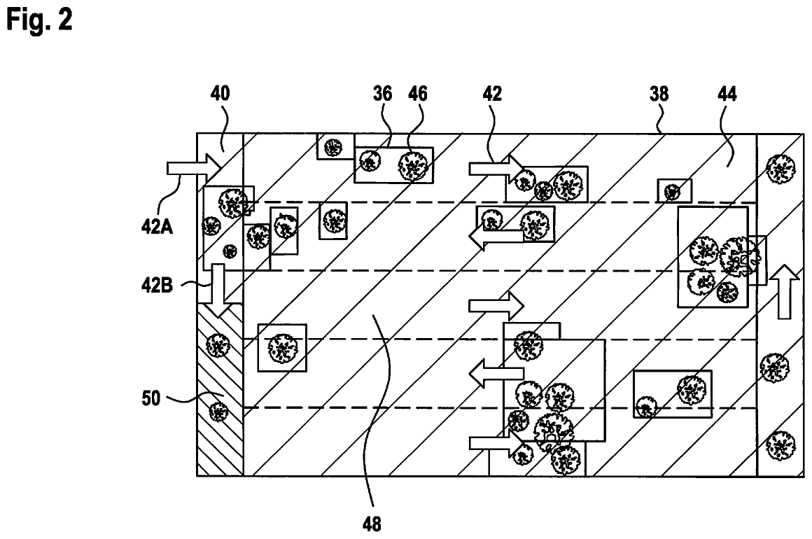

FIG. 2 schematically shows an agricultural area 38, which was treated with the aid of field sprayer 10 according to a first exemplary embodiment of a method according to the present invention. Agricultural area 38 includes a headland 40.

For treating agricultural area 38, field sprayer 10 or tractor 12 has followed agricultural area 38 along arrows 42A, 42, 42B (from 42A via 42 to 42B) in lanes 44 or strips 44. The width of lanes 44 or of strips 44 depends on the working width of field sprayer 10.

Initially, spray agent 36 was selectively applied to detected weeds 46 or weed clusters 46. The initial section, which was treated selectively, is denoted by reference numeral 48. The step of selective application was carried out until the residual amount of spray agent 36 in spraying device 14 was just barely still sufficient to extensively treat the area of a remaining residual section 50 with a predefined application amount, so that, upon completion of the treatment of the agricultural area 38, essentially the entire residual amount of spray agent 36 in spraying device 14 was applied, i.e., spraying device 14 was essentially empty. The step of extensive application was thus started as a function of the residual amount of spray agent 36 and the area of the residual section 50.

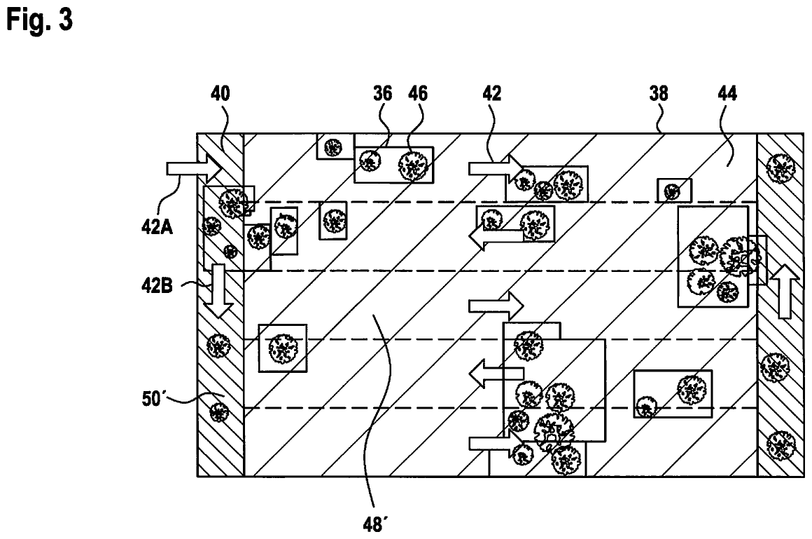

FIG. 3 schematically shows agricultural area 38 from FIG. 2, which was treated with the aid of field sprayer 10 according to a second exemplary embodiment of a method according to the present invention. The path of field sprayer 10 or of tractor 12 also corresponds to that of FIG. 2.

In contrast to the method from FIG. 2, a residual section 50′, which was to be, and was, treated extensively, was predefined or established in advance in the process. This means, in other words, that the step of extensive application was started when residual section 50′ was reached, and thus independently from the residual area. The step of selective application was consequently carried out on an also predefined or previously established initial section 48′ and ended when residual section 50′ was reached. To ensure that, upon completion of the treatment of predefined residual section 50′, essentially the entire residual amount of spray agent 36 has been applied, the residual amount of spray agent 36, upon reaching predefined residual section 50′, was selected or mixed with the aid of the mixing device of spraying device 14 or of spray agent tank 30 as a function of the area of predefined residual section 50′ in such a way that it is essentially exactly sufficient for the extensive treatment with the predefined application amount per area.

In the shown exemplary embodiment, predefined residual section 50′ is a headland 50′ of the agricultural area since, according to the present invention, this section is in any case most heavily infested with weeds.

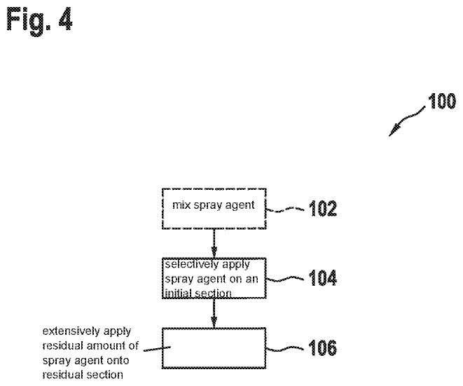

FIG. 4 shows a flow chart of one exemplary embodiment of a method 100 according to the present invention for applying a spray agent 36, in particular a plant protection product 36. Method 100 includes a step 104 of selectively applying spray agent 36 onto an initial section 48, 48′ of the agricultural area. Method 100 furthermore includes a subsequent step 106 of extensively applying a residual amount of spray agent 36 onto a residual section 50, 50′ of the agricultural area using a predefined application amount in such a way that, upon completion of the treatment of agricultural area 38, essentially the entire residual amount of spray agent 36 in spraying device 14 has been applied.

In addition, method 100 optionally includes a step 102 of mixing spray agent 36, in particular with the aid of a mixing device of spraying device 14, prior to steps 104, 106 of applying spray agent 36.

If one exemplary embodiment includes an “and/or” linkage between a first feature and a second feature, this should be read in such a way that the exemplary embodiment according to one specific embodiment includes both the first feature and the second feature, and according to an additional specific embodiment includes either only the first feature or only the second feature.

1-14. (canceled)

15. A method for applying a spray agent onto an agricultural area to be treated using a spraying device, the spraying device including a spray agent tank for the spray agent to be applied and at least one fluidic connecting line from the spray agent tank to a nozzle, the method comprising the following steps:
selectively applying the spray agent onto an initial section of the agricultural area; and
subsequent to the selective application, extensively applying a residual amount of spray agent onto a residual section of the agricultural area using a predefined application amount in such a way that, upon completion of treatment of the agricultural area, the entire residual amount of spray agent has been applied.

16. The method as recited in claim 15, wherein the spray agent is a plant protection product.

17. The method as recited in claim 15, wherein the step of extensive application is started as a function of the residual amount of spray agent and an area of the residual section so that, upon completion of the treatment of the agricultural area, the entire residual amount of spray agent has been applied.

18. The method as recited in claim 15, wherein the residual section is a predefined area of the agricultural area, the step of extensive application being started when the predefined residual section is reached, and the residual amount of spray agent being mixed in such a way, that, upon completion of treatment of the predefined area, the entire residual amount of spray agent has been applied.

19. The method as recited in claim 18, wherein the predefined area of the agricultural area is a headland of the agricultural area.

20. The method as recited in claim 15, further comprising the following step:
mixing the spray agent using a mixing device of the spraying device prior to the steps of selective application and extensive application.

21. The method as recited in claim 15, wherein, in the step of extensive application, the predefined application amount is in a range of a permissible amount per spray agent per area for a corresponding application case.

22. The method as recited in claim 15, wherein, in the step of extensive application, the predefined application amount is constant per area.

23. The method as recited in claim 15, wherein the residual amount is an amount of mixed spray agent instantaneously present in the spraying device.

24. The method as recited in claim 15, wherein the residual amount is an instantaneously present amount of spray agent in the spray agent tank and/or in the at least one fluidic connecting line.

25. The method as recited in claim 15, further comprising the following step:
rinsing the spray agent tank and/or the at least one fluidic connecting line upon completion of the step of extensive application, a resulting rinsing amount being applied to a sub-section of the initial section, to which no or relatively little spray agent was applied in the steps of selective application and extensive application, so that the applied amount is in a range of a permissible amount per spray agent per area for a corresponding application case.

26. A control unit configured to control an application of a spray agent onto an agricultural area to be treated using a spraying device, the spraying device including a spray agent tank for the spray agent to be applied and at least one fluidic connecting line from the spray agent tank to a nozzle, the control device configured to:
selectively apply the spray agent onto an initial section of the agricultural area; and
subsequent to the selective application, extensively apply a residual amount of spray agent onto a residual section of the agricultural area using a predefined application amount in such a way that, upon completion of treatment of the agricultural area, the entire residual amount of spray agent has been applied.

27. A non-transitory machine-readable storage medium on which is stored a computer program for applying a spray agent onto an agricultural area to be treated using a spraying device, the spraying device including a spray agent tank for the spray agent to be applied and at least one fluidic connecting line from the spray agent tank to a nozzle, the computer program, when executed by a computer, causing the computer to perform the following steps:
selectively applying the spray agent onto an initial section of the agricultural area; and
subsequent to the selective application, extensively applying a residual amount of spray agent onto a residual section of the agricultural area using a predefined application amount in such a way that, upon completion of treatment of the agricultural area, the entire residual amount of spray agent has been applied.

28. A device for applying a spray agent, comprising:
a spraying device including a spray agent tank and at least one fluidic connecting line from the spray agent tank to a nozzle; and and
a control unit configured to control an application of a spray agent onto an agricultural area to be treated using the spraying device, the control device configured to:
selectively apply the spray agent onto an initial section of the agricultural area; and
subsequent to the selective application, extensively apply a residual amount of spray agent onto a residual section of the agricultural area using a predefined application amount in such a way that, upon completion of treatment of the agricultural area, the entire residual amount of spray agent has been applied.

29. The device as recited in claim 28, wherein the device is an agricultural field sprayer.

30. A device for applying a spray agent, comprising:
a spraying device including a spray agent tank and at least one fluidic connecting line from the spray agent tank to a nozzle;
a processing unit which is configured to ascertain an area and/or driving distance which is treatable with a residual amount of mixed spray agent present in the spraying device during an extensive application of the residual amount using a predefined application amount; and
a display unit which is configured to visualize the ascertained area and/or driving distance for an operator and/or to output a signal when the ascertained area and/or driving distance corresponds to an area and/or driving distance of a residual section of the agricultural area.

31. The device as recited in claim 30, wherein the device is an agricultural field sprayer.
